(19) United States
(12) Patent Application Publication
(10) Pub. No.: US 2018/0162702 A1
(43) Pub. Date: Jun. 14, 2018

(54) VARIABLE SPEED SINGLE FAILURE PROOF LIFTING DEVICE

(71) Applicant: Whiting Corporation, Monee, IL (US)

(72) Inventors: Robert Sean O'Connor, Dyer, IN (US); David Paul Weber, Oley, PA (US)

(73) Assignee: Whiting Corporation

(21) Appl. No.: 15/833,661

(22) Filed: Dec. 6, 2017

Related U.S. Application Data
(60) Provisional application No. 62/432,190, filed on Dec. 9, 2016.

(51) Int. Cl. B66D 3/22; B66C 15/02; B66D 5/00

(52) U.S. Cl. CPC B66D 3/22; B66D 5/00; B66C 15/02

(57) ABSTRACT

A lifting device includes a primary attachment point for engagement with a hoist of a crane, a plurality of redundant attachments for engagement with a structure adjacent the hoist, a first hoist having a first hoist wire for holding or moving a load, a second hoist having a second hoist wire for holding or moving the load; and, a reeving system for engagement with the first hoist wire and the second hoist wire such that at least one hoist wire will hold the load if another hoist wire fails.

### RELATED APPLICATION

This application claims the benefit of U.S. Provisional Application No. 62/432,190, filed on Dec. 9, 2016, pending, which is incorporated herein by reference.

### TECHNICAL FIELD

The present disclosure relates to a lifting device, and in particular, to a variable speed single failure proof lifting device.

### BACKGROUND

A nuclear reactor operates by facilitating a controlled nuclear chain reaction in a reactor core. Typically, the nuclear reaction is fueled by an isotope of uranium, which is supplied to the reactor core in a plurality of elongated fuel rods, which are typically metallic structures that are packed with uranium pellets. Periodically, the fuel rods must be removed and replaced, and the spent nuclear fuel must be safely moved and then stored to avoid contamination of the environment. This spent nuclear fuel remains highly radioactive and is also capable of generating significant thermal energy. The removing and replacing of nuclear fuel rods is a complex and lengthy process referred to as a “refueling outage.”

During the 1960's and 1970's, when a majority of nuclear power plants in the United States were constructed, nuclear containment domes were typically outfitted with polar cranes for moving various loads, including components of a nuclear reactor. These polar cranes generally consist of a circular frame suspended within the containment dome, a bridge extending across the frame for providing circular motion, a trolley movable along the bridge for providing horizontal motion, a main hoist mounted to the trolley for vertically lifting larger loads (for example, in excess of 100 tons), and an auxiliary hoist mounted to the trolley for vertically lifting smaller loads (for example, less than 25 tons).

At that time, it was common for complete refueling outages to extend several months in duration. Given the duration of the refueling outages, in order to minimize costs, the main hoists of these polar cranes were generally designed with slow maximum lift speeds of less than 5 feet per minute (FPM), while auxiliary hoists were generally designed with maximum lift speeds of less than 25 FPM.

Today, with improved efficiencies in the refueling outage process, it is common for refueling outages to extend less than 30 days in duration, with some extending less than 20 days. A beneficial result of the decrease in refueling outage duration is a corresponding increase in power plant energy generation, and therefore, value to utilities.

Nuclear power plants outfitted with polar cranes are subject to current standard regulations, such as Nuclear Regulation (NUREG) Standards 0554 and 0612, and American Society of Engineers (ASME) Standard B30.2, the entireties of which are herein incorporated by reference. NUREG 0554, for example, specifies how polar cranes may comply with certain “single failure proof” (SFP) lifting requirements, such that a single failure of a component of the polar crane will not result in a loss of a crane's capability to safely retain a load. In some plants, a polar crane may not operate during a refueling outage when the nuclear reactor is disassembled unless it complies with certain SFP lifting requirements. NUREG 0554 also specifies that lifts exceeding certain loads may not exceed specific lift speeds. For example, lifts of 50 tons or more may not exceed lift speeds of 10 FPM.

ASME 830.2, for example, specifies certain upper limit switch testing requirements. Compliance with ASME B30.2 requires complete lifts to be performed at least once daily to confirm lift limit switch operation. With lifts of approximately 100 feet or more, the time required to lower and raise the main hoist (a total of 200 feet) at maximum lift speeds of 5 FPM or less may exceed an hour or more, while the time required to lower and raise the auxiliary hoist at maximum lift speeds of 25 FPM or less may exceed 10 minutes.

Today, aged polar cranes are frequently the source of inefficiency during refueling outages. Currently there are no SFP lifting systems on polar cranes inside pressurized water reactor containments. Polar cranes with slow lift speeds also contribute to inefficient operations. In this regard, polar cranes are now often times the critical piece of equipment extending the duration of a refueling outage.

An unmet need exists for a lifting device that may be used with existing polar cranes to increase maximum lift speeds for both large and small capacities, and that meets today's standard regulations, including SPF lifting requirements. Likewise, an unmet need exists for a method of using a lifting device with existing polar cranes to increase maximum lifts speeds in compliance with today's standard regulations.

### BRIEF SUMMARY

In one aspect, a lifting device includes a primary attachment point for engagement with a hoist of a crane, a plurality of redundant attachments for engagement with a structure adjacent the hoist, a first hoist having a first hoist wire for holding or moving a load, a second hoist having a second hoist wire for holding or moving the load, and a reeving system for engagement with the first hoist wire and the second hoist wire such that at least one hoist wire will hold the load if the other hoist wire fails. The primary attachment point may include a hook adapter for engagement with a hook positioned on the hoist of the crane. The plurality of redundant attachments may include at least one hook for engagement with structure adjacent the hoist of the crane. The first hoist and the second hoist may operate in parallel such that the first hoist wire and the second hoist wire move at the same speed. The first hoist may include a first wire rope drum, while the second hoist may include a second wire rope drum.

In another aspect, a lifting device includes a plurality of attachments for engagement with a structure adjacent a hoist of a crane, a hoist having a hoist wire for holding or moving a load; and a variable speed power source coupled to the hoist for rotating a hoist drum at multiple speeds. The power source may include a motor and a gear box for shifting between multiple gear ratios. The lifting device may also include a first brake positioned between the gear box and the hoist drum. The lifting device may also include a second brake and a second gear box coupled to the hoist drum on a side of the hoist drum opposite the coupling to the variable speed power source, with the second gear box being positioned between the second brake and the hoist drum. A design of the first brake may be different than a design of the second brake. The lifting device may also include a fixed-ratio gear box positioned between the first brake and the hoist drum. A design of the fixed-ratio gear box may be different than a design of the second gear box. The plurality of redundant attachments may include at least one hook for engagement with the structure adjacent the hoist of the crane. The lifting device may also include an attachment point for engagement with the hoist of the crane, where the attachment point is separate from the plurality of attachments for engagement with the structure adjacent the hoist of the crane.

In another aspect, a lifting device includes a first hoist having a first hoist wire for holding or moving a load, a second hoist having a second hoist wire for holding or moving the load, a first power source coupled to a first hoist, a second power source coupled to a second hoist, a first brake positioned between the first power source and a first hoist drum, and a second brake positioned between the second power source and a second hoist drum. The lifting device may also include a reeving system for engagement with the first hoist wire and the second hoist wire such that at least one hoist wire will hold the load if the other hoist wire fails. The lifting device may also include an attachment point for engagement with a hoist of a crane. The lifting device may also include a plurality of redundant attachments for engagement with a structure adjacent the hoist of the crane, where the plurality of attachments is separate from the attachment point for engagement with the hoist of a crane. The lifting device may also include a third brake positioned on a side of the first hoist drum opposite the coupling to the first power source, and a fourth brake positioned on a side of the second hoist drum opposite the coupling to the second power source. The lifting device may also include a first multi-speed gear box and a second multi-speed gear box, wherein the first multi-speed gear box is positioned between the first power source and the first brake, and the second multi-speed gear box is positioned between the second power source and the second brake.

### BRIEF DESCRIPTION OF THE DRAWINGS

FIG. 1 is a perspective view of a typical hook and hook block attached to a main hoist of a crane;

FIG. 2 is a perspective view of a lifting device for use with a crane;

FIG. 3 is a top view of the lifting device of FIG. 2;

FIG. 4 a perspective view of a hoisting system of the lifting device of FIG. 3;

FIGS. 5A-B are perspective views of the reeving system of the lifting device of FIG. 2;

FIG. 6 is a perspective view of a hook block assembly of the lifting device of FIG. 2; and,

FIG. 7 is a perspective view illustrating the lifting device of FIG. 2 engaged with the main hoist and trolley frame of a polar crane.

### DETAILED DESCRIPTION

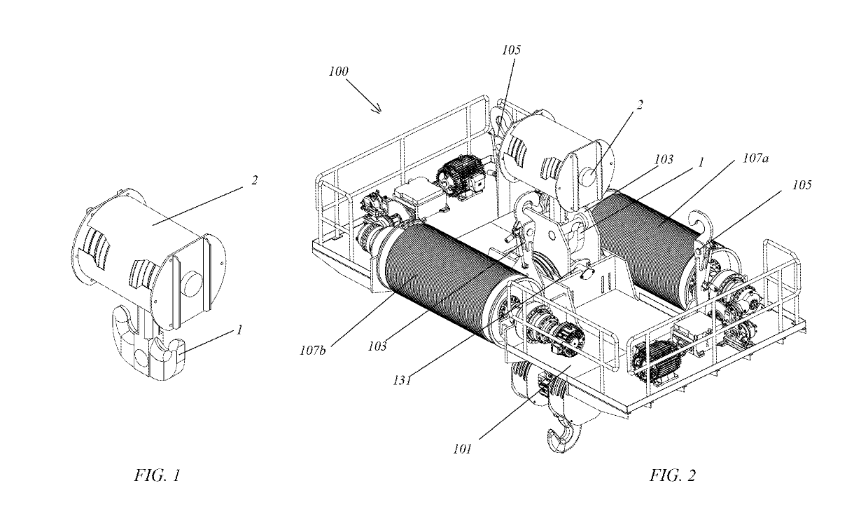

As noted above, polar cranes within nuclear power plants generally consist of a circular frame suspended within a containment dome, a bridge extending across the frame for providing circular motion, a trolley movable along the bridge for providing horizontal motion, a main hoist mounted to the trolley for vertically lifting larger loads (for example, in excess of 100 tons), and an auxiliary hoist mounted to the trolley for vertically lifting smaller loads (for example, less than 25 tons). The main hoist of a polar crane may have any number of hook arrangements for engaging various load types. FIG. 1, for example, shows a typical dual-barbed hook 1 connected to a hook block 2 of a main hoist of a crane. Single-barbed hooks are also common.

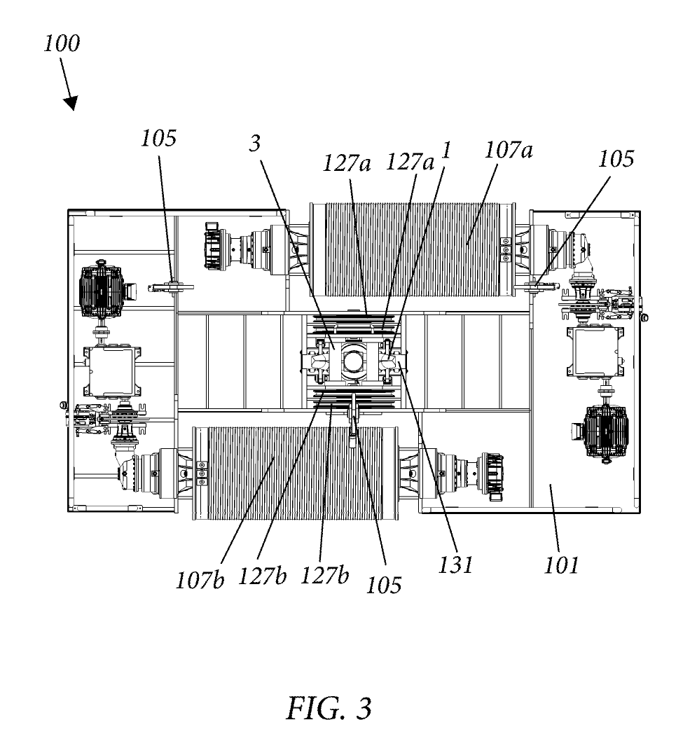

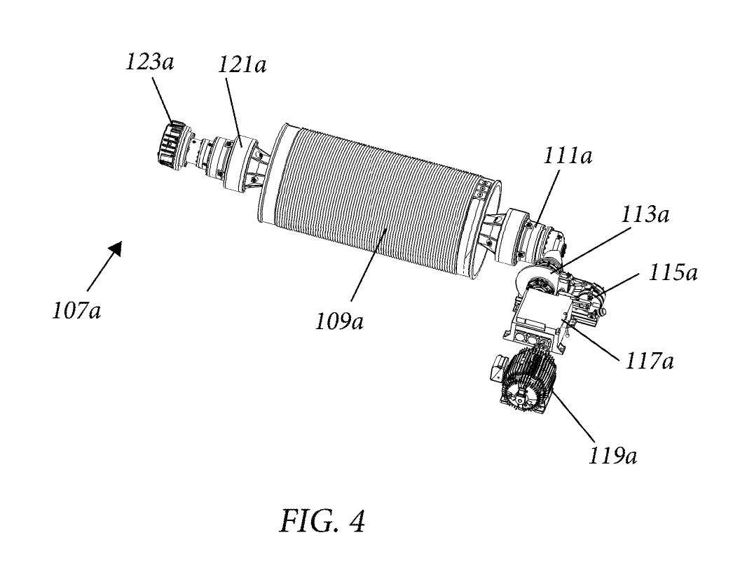

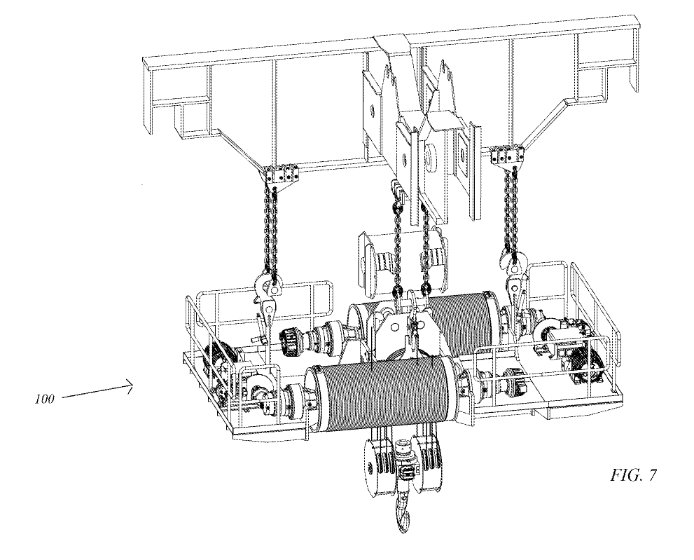

The lifting device 100 described herein is a “below the hook” lifting device configured for attachment to a hook of a crane, and in particular, to the main hoist of a polar crane installed in a nuclear power plant, as shown in FIG. 7. FIGS. 2-3 are perspective and top views of the lifting device 100.

The lifting device includes a platform or frame 101 for supporting the components of the lifting device 100, as described below, and to permit technicians to access the components, for example, after the lifting device 100 has been hoisted by the main hoist of a crane. A hook interface 103 is connected or welded to the platform 101 and is configured for engagement with the main hoist of a crane. For example, as shown in FIG. 2, the hook interface 103 may be configured for engagement with the dual-barbed hook 1 of FIG. 1. However, the hook interface 103 may be configured for engagement with other hook arrangements, as well as more permanent connections to the hoist of a crane. For example, the hook interface 103 may be permanently fixed to the hoist cable of a crane. The hook interface 103 may also include a weight scale to wirelessly transmit the load in the hood interface 103 to a remote device. As described below, the hook interface 103 operates as the primary attachment point for attaching the lifting device 100 to the hoist of a crane.

The lifting device 100 also includes a plurality of redundant attachments 105 connected or welded to the frame 101. The redundant attachments 105 are configured for engagement with a structure adjacent the hoist of the crane that is used to lift the lifting device 100, after the crane has hoisted the lifting device 100 to near the upper limit of the crane. As shown in FIG. 2, the plurality of redundant attachments 105 may include three separate attachments arranged in a circular pattern and spaced approximately 120° apart to provide load stability. However, fewer or additional redundant attachments 105 may be used in various other arrangements. For example, the plurality of redundant attachments 105 may include four separate attachments arranged in a square pattern. The redundant attachments 105 shown in FIG. 2 are configured as hooks for engaging the trolley frame of a polar crane used to hoist the lifting device 100, without drilling or modification of the trolley frame. However, it should be appreciated that other attachment configurations may be used for engaging other adjacent structures. For example, as shown in FIG. 7, hooks or chains adapted to engage the redundant attachments 105 may be fixed to the trolley frame or other adjacent structure. The redundant attachments 105 may be remotely actuated, for example, via radio signals, to automatically engage or disengage the structure adjacent the crane after the crane has hoisted the lifting device 100 to near the upper limit of the crane. Each of redundant attachments 105 may also include a load cell for wirelessly transmitting the load supported by each redundant attachment 105 to a remote device.

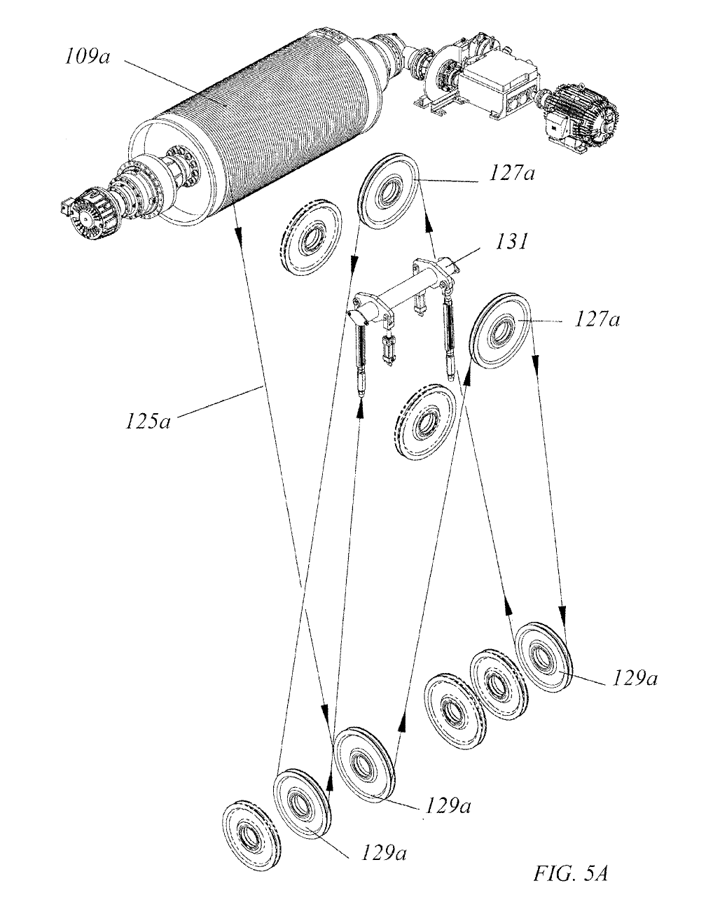

The lifting device 100 further includes two hoisting systems configured to work together in parallel, or alternatively, independent of the other in the case of a failure of one hoisting system. As shown in FIGS. 2-3, the first hoisting system 107a and the second hoisting system 107b are mounted to the frame 101 opposite one another. The first hoisting system 107a and the second hoisting system 107b are shown and described together with reference to FIG. 4, which is a perspective view of the first hoisting system 107a. Although the first hoisting system 107a and the second hoisting systems 107b are described herein as being comprised of the same components, it should be appreciated that they may alternatively be comprised of different components.

In general, the hoisting system 107a includes a wire rope drum 109a, a fixed-ratio gear box 111a, a torque limiting device 113a, a disk brake assembly 115a, a multi-speed gear box 117a, an electric motor 119a, a second fixed-ratio gear box 121a, and a second brake 123a. Likewise, the second hoisting system 107b includes a wire rope drum 109b, a fixed-ratio gear box 111b, a torque limiting device 113b, a disk brake assembly 115b, a multi-speed gear box 117b, an electric motor 119b, a second fixed-ratio gear box 121b, and a second brake 123b. A wireless or radio control system may be configured to remotely control the components of the hoisting systems 107a and 107b, including for example, the electric motor 119a, the multi-speed gear box 117a, the brake assembly 115a, and the second brake 123a.

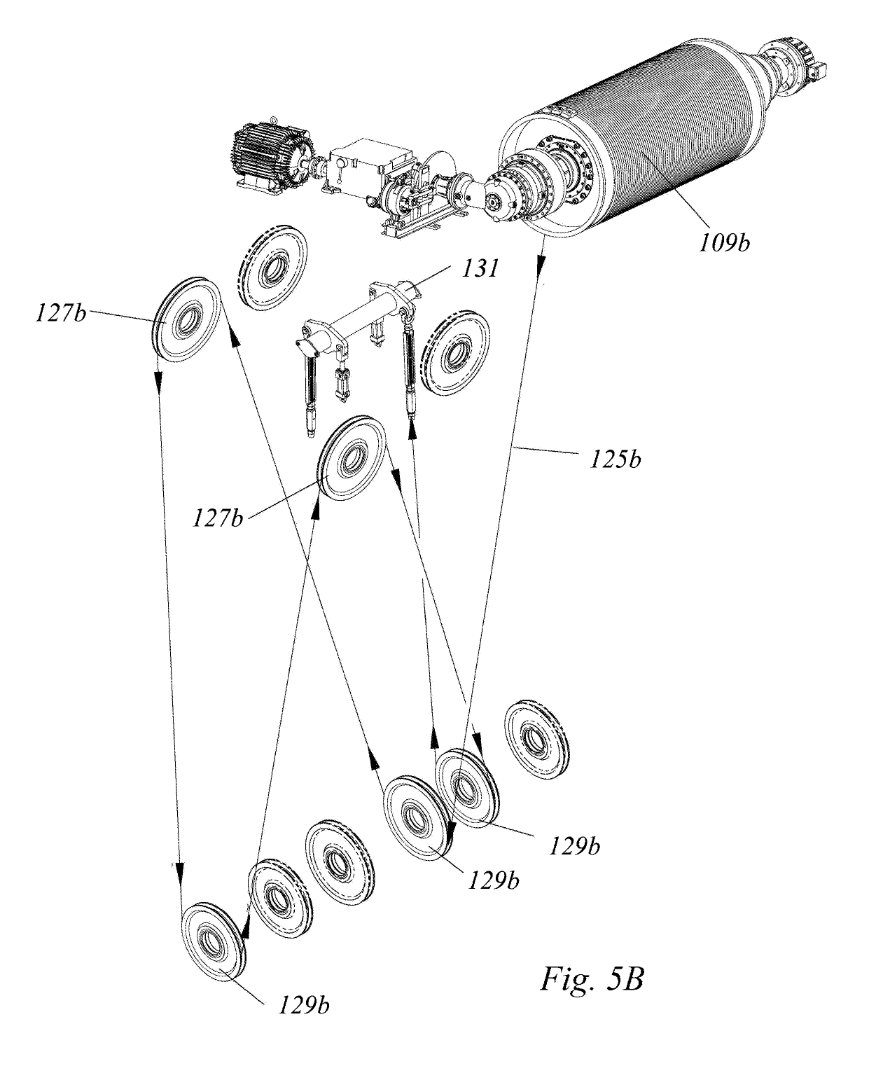

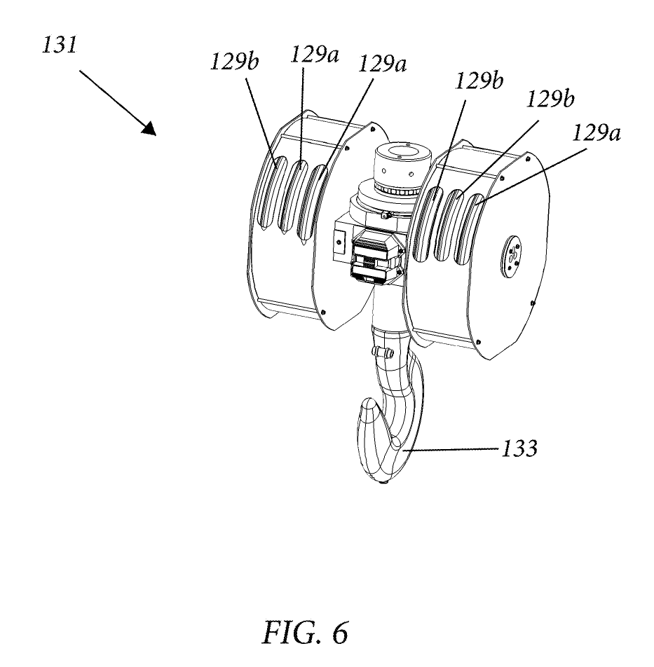

As shown in FIGS. 5A-B, the wire rope drum 109a and 109b are each configured to separately feed a wire rope 125a and 125b from the wire rope drum 109a and 109b to a reeving system designed such that a failure of one of the wire ropes will not result in the loss or control of a load supported by the reeving system. For example, the reeving system shown in FIGS. 5A and 5B generally includes an upper sheave nest having sheaves 127a and 127b, a lower sheaves nest having sheaves 129a and 129b, and an equalizer bar assembly 131. Each wire rope 125a and 125b is fixed at one end to the wire rope drum 109a and 109b, respectively. As shown, each wire rope 125a and 125b is reeved around the sheaves 127a, 129a, and 127b, 129b, respectively. Each wire rope 125a and 125b is then fixed at the other end to an equalizer bar assembly 131, which is fixed to the frame 101. As best seen in FIG. 3, the upper sheaves 127a and 127b are rotatably mounted to the frame 101. As seen in FIG. 6, the lower sheaves 129a and 129b are rotatably mounted and housed in a hook block assembly 131, which includes a hook 133 for lifting loads using the lifting device 100. The wire rope drum 109a and 109b may be operated at the same speed to raise or lift a load. In this way, the lifting device 100 is single failure proof in that two hoists are tied together in a dual and balanced single failure proof reeving system.

It should be appreciated that other reeving systems may also be used with the lifting device 100, including for example, the reeving system shown and described in U.S. Pat. Nos. 3,786,935 and 6,788,755, and the reeving system shown and described in ASME NOG-1-2004, the entireties of which are incorporated herein by reference.

Each wire rope drum 109a and 109b may be driven by an electric motor 119a or 119b. For example, the wire rope drum 109a may be mechanically coupled to the electric motor 119a through a drive assembly comprising a multi-speed gear box 117a, a disk brake assembly 115a, a torque limiting device 113a, and a fixed-ratio gear box 111a. The electric motor may be a variable-speed squirrel cage motor. The multi-speed gear box 117a may be electrically actuated to shift between multiple gear ratios to provide lower torque at a higher speed, and to provide higher torque at a lower speed.

Notably, the disk brake assembly 115a is positioned between the multi-speed gear box 117a and the wire rope drum 109a, as the gear box 117a is not capable of supporting a load when the gearbox 117a is shifting. Positioning of brake assembly 115a on the output side of the gearbox 117a places the brake assembly 115a closer to the load, allowing the multi-speed gearbox 117a to shift safely.

A second fixed-ratio gear box 121a and a second brake 123a are mechanically coupled to the wire rope drum 109a on a side of the wire rope drum 109a opposite the electric motor 119a. The second fixed-ratio gear box 121a may be different in design than the fixed-ratio gear box 111a. Likewise, the second brake 123a may be different in design than the brake assembly 115a. Supplying different designs eliminates common mode failures.

Use of the lifting device 100 begins by lowering the hoist of a crane such as for example, a hook 1 connected to a hook block 2 of the main hoist of a polar crane in a nuclear power plant. After the hook 1 is engaged with the hook interface 103 of the lifting device 100, the crane hoists the lifting device 100 to a position near the upper limit of the crane's hook travel. Once in the lifted position, the plurality of redundant attachments 105 are remotely actuated to engage the structure adjacent the hoist of the crane, such as for example, the trolley frame of the polar crane, or hooks or chains fixed to the trolley frame, as shown in FIG. 7. The load cells in each of the redundant attachments 105 may then provide weight readouts indicating which attachments are supporting the weight of the lifting device 100.

After engagement of the redundant attachments 105, the hook 1 on the hoist of the crane may be raised or lowed to balance the weight of the lifting device 100 between the hook interface 103, which operates as the primary attachment point of the lifting device 100, and the redundant attachments 105. With weight applied to the redundant attachments 105, the electric actuators which couple and uncouple the redundant attachments 105 no longer have the electric or mechanical power to disconnect the redundant attachments 105 should an operator inadvertently attempt to disengage the redundant attachments 105, or an electrical malfunction sends a disengage signal to the actuators. This serves as a built in passive safety feature. Likewise, the combination of the primary attachment point and the redundant attachments 105 provide single failure proof attachment of the lifting device 100 to a crane and/or adjacent structure. Thus, failure of any one attachment will not result in a loss of the capability of the lifting device 100 to safely retain a load.

Once in the lifted position, electric power to the main hoist of the polar crane may be disconnected from the main hoist and reconnected to the lifting device 100 for powering the components of the lifting device 100. Removing power from the main hoist of the polar crane is another passive safety feature of the lifting device 100 in that the main hoist is no longer capable of movement without electric power. Since the brakes of a main hoist on a polar crane are regarded as failsafe, in this state, the main hoist of the polar crane is in the safest possible condition.

Once electric power is transferred from the main hoist of the polar crane to the lifting device 100, the lifting device 100 is self-contained and may be operated remotely via wireless radio control or manually via a pushbutton pendant control. In particular, the electric motors 119a and 119b, and the multi-speed gear boxes 117a and 117b may be selectively controlled to perform lifts at various lift speeds, depending on the load to be lifted, and any restrictions set by standard regulations.

For example, the lifting device 100 may hoist loads of 50 tons at 10 FPM. With lifts of approximately 100 feet or more, the time required to lower and raise a 50 ton load (a total of 200 feet) with the lifting device 100 at a lift speed of 10 FPM is 20 minutes. Alternatively, the lifting device 100 may hoist loads of 25 tons at 40 FPM. The time required to lower and raise a 25 ton load (a total of 200 feet) with the lifting device 100 at a lift speed of 40 FPM is 5 minutes. Under light or no loads, the speed can be increased to 80 FPM. The time required to lower and raise (a total of 200 feet) the hoist of the lifting device 100 with no load at a lift speed of 80 FPM is 2.5 minutes. Moreover, the lifting device 100 complies with NUREG 0554 SFP lift requirements, such that the lifting device may be utilized during refueling outages, where required.

As set forth above, use of the lifting device 100 with aged polar cranes will permit single failure proof lifts. Also, selectively increasing or decreasing lift speeds has the ability to dramatically increase efficiencies during refueling outages. The lifting device 100 also adds utility to polar cranes that would otherwise be expensive to replace.

1. A lifting device comprising:
a primary attachment point for engagement with a hoist of a crane;
a plurality of redundant attachments for engagement with a structure adjacent the hoist;
a first hoist having a first hoist wire for holding or moving a load;
a second hoist having a second hoist wire for holding or moving the load; and,
a reeving system for engagement with the first hoist wire and the second hoist wire such that at least one hoist wire will hold the load if the other hoist wire fails.

2. The lifting device of claim 1, wherein the primary attachment point comprises a hook adapter for engagement with a hook positioned on the hoist of the crane.

3. The lifting device of claim 1, wherein the plurality of redundant attachments comprise at least one hook for engagement with the structure adjacent the hoist of the crane.

4. The lifting device of claim 1, wherein the first hoist and the second hoist operate in parallel such that the first hoist wire and the second hoist wire move at the same speed.

5. The lifting device of claim 1, wherein the first hoist comprises a first wire rope drum, and the second hoist comprises a second wire rope drum.

6. A lifting device comprising:
a plurality of attachments for engagement with a structure adjacent a hoist of a crane;
a hoist having a hoist wire for holding or moving a load; and,
a variable speed power source coupled to the hoist for rotating a hoist drum at multiple speeds.

7. The lifting device of claim 6, wherein the power source comprises a motor and a gear box for shifting between multiple gear ratios.

8. The lifting device of claim 7, further comprising a first brake positioned between the gear box and the hoist drum.

9. The lifting device of claim 8, further comprising a second brake and a second gear box coupled to the hoist drum on a side of the hoist drum opposite the coupling to the variable speed power source, the second gear box positioned between the second brake and the hoist drum.

10. The lifting device of claim 9, wherein a design of the first brake is different than a design of the second brake.

11. The lifting device of claim 9, further comprising a fixed-ratio gear box positioned between the first brake and the hoist drum.

12. The lifting device of claim 6, wherein a design of the fixed-ratio gear box is different than a design of the second gear box.

13. The lifting device of claim 6, wherein the plurality of redundant attachments comprise at least one hook for engagement with the structure adjacent the hoist of the crane.

14. The lifting device of claim 6, further comprising an attachment point for engagement with the hoist of the crane, the attachment point being separate from the plurality of attachments for engagement with the structure adjacent the hoist of the crane.

15. A lifting device comprising:
a first hoist having a first hoist wire for holding or moving a load;
a second hoist having a second hoist wire for holding or moving the load;
a first power source coupled to the first hoist;
a second power source coupled to the second hoist;
a first brake positioned between the first power source and a first hoist drum;
a second brake positioned between the second power source and a second hoist drum.

16. The lifting device of claim 15, further comprising a reeving system for engagement with the first hoist wire and the second hoist wire such that at least one hoist wire will hold the load if the other hoist wire fails.

17. The lifting device of claim 15, further comprising an attachment point for engagement with a hoist of a crane.

18. The lifting device of claim 17, further comprising a plurality of redundant attachments for engagement with a structure adjacent the hoist of the crane, the plurality of attachments being separate from the attachment point for engagement with the hoist of a crane.

19. The lifting device of claim 15, further comprising a third brake positioned on a side of the first hoist drum opposite the coupling to the first power source, and a fourth brake positioned on a side of the second hoist drum opposite the coupling to the second power source.

20. The lifting device of claim 15, further comprising a first multi-speed gear box and a second multi-speed gear box, wherein the first multi-speed gear box is positioned between the first power source and the first brake, and the second multi-speed gear box is positioned between the second power source and the second brake.
